(19) United States
(12) Patent Application Publication
(10) Pub. No.: US 2011/0191739 A1
(43) Pub. Date: Aug. 4, 2011

(54) CIRCUIT DESIGN METHOD, CIRCUIT DESIGN SYSTEM, AND RECORDING MEDIUM

(75) Inventors: Takashi Hasegawa, Tokyo (JP); Shinya Sato, Tokyo (JP)

(73) Assignee: ADVANTEST CORPORATION, Tokyo (JP)

(21) Appl. No.: 13/121,829

(22) PCT Filed: Sep. 25, 2009
(86) PCT No.: PCT/JP2009/004867

§ 371 Date: Mar. 30, 2011

(30) Foreign Application Priority Data
Sep. 30, 2008 (JP) 2008-255056

(51) Int. Cl. G06F 17/50

(52) U.S. Cl. 716/126

(57) ABSTRACT

A circuit design method for interconnecting a plurality of modules includes: a step of acquiring port information including input ports and output ports of the plurality of modules; a step of acquiring instance information indicating that, among the plurality of modules, there is a module including a plurality of instances having the same function; and a step of associating the input ports and the output ports based on the port information and the instance information to interconnect the plurality of modules.

### BACKGROUND

1. Technical Field

The present invention relates to a circuit design method, a circuit design system, and a recording medium, and particularly to automatic generation of interconnections between a plurality of modules using a circuit design tool.

2. Related Art

Recently, the miniaturization and high integration of integrated circuits (e.g., ASIC (Application Specific Integrated Circuit) have been enhanced, and hence the circuit size of one semiconductor chip has been increasing. In order to cope with such a large-scale circuit design, a circuit is divided by functional block (module) and divided individual modules are designed by a plurality of designers separately. Respectively designed modules are then interconnected according to predetermined correspondence relationships so that one high-level module can be designed. Similarly, designed individual high-level modules are then interconnected according to predetermined correspondence relationships so that one higher-level module can be designed. Thus, higher hierarchies are generated in turn so that the circuit design of the entire semiconductor chip can be eventually attained.

As a tool for attaining such a circuit design, RTL (Register Transfer Level) design using a language such as Verilog-HDL or VHDL is now the mainstream, but high-level design (high-level synthesis) for designing from a higher abstraction-level model rather than the RTL is being adopted these days. According to the high-level design, only the functionality is described according to an algorithm along a predetermined process flow so that an RTL model can be automatically generated from the algorithmic descriptions using a high-level synthesis tool (behavior synthesis tool). As the behavior synthesis tool, for example, “Cyber Work Bench (CWB)” provided by NEC System Technologies, Ltd. is known.

In the meantime, when designed individual modules are interconnected in the above-mentioned circuit design, if respective modules are different from each other, input/output port names of modules can be decided according to predetermined correspondence relationships to automatically connect modules based on information on the input/output port names alone. However, if there are a plurality of identical modules among modules to be connected, since the identical modules usually have the same input/output port names, the modules cannot be automatically connected based on the information on the input/output port names alone, and hence the modules have to be connected manually. Such manual work cannot avoid human-caused connection mistakes, and it may result in reduction in model quality. When a connection mistake has been made, it is difficult to find out the mistake on site, e.g., the mistake may not be found out until a logic verification step, causing a problem of decreasing design productivity as well.

Especially, in an ASIC used for a semiconductor testing device, several functional blocks, such as a timing generator, a pattern generator, a waveform shaper, and a logic comparator, are combined into one chip to conduct a test on a tested IC. Among them, the timing generator, the pattern generator, and the waveform shaper need to be provided with more than a thousand identical functional blocks in one semiconductor testing device system, and this requires that a plurality of identical functional blocks be provided in one chip. Thus, especially in the ASIC used for a semiconductor testing device, it is important to solve the above problems.

### SUMMARY

Therefore, it is an object of the present invention to provide a circuit design technique capable of solving the above problems. This object is achieved by a combination of features as set forth in independent claims in the appended claims. The dependent claims are to provide for further effective specific examples of the present invention.

One aspect of a circuit design method according to the present invention is a circuit design method for interconnecting a plurality of modules, the method comprising: a step of acquiring port information including input ports and output ports of the plurality of modules; a step of acquiring instance information indicating that, among the plurality of modules, there is a module including a plurality of instances having the same function; and a step of associating the input ports and the output ports based on the port information and the instance information to interconnect the plurality of modules.

According to the one aspect of the circuit design method of the present invention, the instance information can include number-of-instances information indicative of the number of the plurality of instances.

Also, according to the one aspect of the circuit design method of the present invention, the instance information can include instance identification information identifying each of the plurality of instances, respectively.

Further, according to the one aspect of the circuit design method of the present invention, the associating step can include generating tentative port information from the port information based on the instance information and associating the input ports and the output ports based on the tentative port information to interconnect the plurality of modules.

Further, according to the one aspect of the circuit design method of the present invention, the method can further comprise a step of acquiring common connection information indicating that an output port of a predetermined module is commonly connected to each input port of the plurality of instances, wherein the associating step includes generating tentative port information from the port information based on the instance information and the common connection information and associating the input ports and the output ports based on the tentative port information to interconnect the plurality of modules.

Further, according to the one aspect of the circuit design method of the present invention, the method can further comprise, before the step of acquiring the port information, a step of acquiring information on a high-level module generated by interconnecting the plurality of modules.

Further, according to the one aspect of the circuit design method of the present invention, the method can further comprise, after the associating step, a step of storing the associated connection information as a connection information database.

Further, according to the one aspect of the circuit design method of the present invention, the method can further comprise, after the associating step, a step of generating a source file of a high-level module generated by interconnecting the plurality of modules.

Further, according to the one aspect of the circuit design method of the present invention, the method can further comprise, after the associating step, a step of displaying at least information indicative of instance names, the port information, and the connection information between the input ports and the output ports to interconnect the plurality of modules.

Further, according to the one aspect of the circuit design method of the present invention, the method can be applied to the circuit design of a semiconductor device used for a semiconductor testing device.

One aspect of a circuit design system according to the present invention is a circuit design system for interconnecting a plurality of modules, the system comprising: port information acquiring means for acquiring port information including input ports and output ports of the plurality of modules; instance information acquiring means for acquiring instance information indicating that, among the plurality of modules, there is a module including a plurality of instances having the same function; and association means for associating the input ports and the output ports based on the port information and the instance information to interconnect the plurality of modules.

Note that, in this specification, the term “means” does not stand for mere physical means and the meaning of the term also includes a case where the function of the means is implemented by software. Further, the function of one means may be implemented by two or more physical means, or the functions of two or more means may be implemented by one physical means.

One aspect of a computer readable recording medium storing a program according to the present invention is to interconnect a plurality of modules, the program executing: a step of acquiring port information including input ports and output ports of the plurality of modules; a step of acquiring instance information indicating that, among the plurality of modules, there is a module including a plurality of instances having the same function; and a step of associating the input ports and the output ports based on the port information and the instance information to interconnect the plurality of modules.

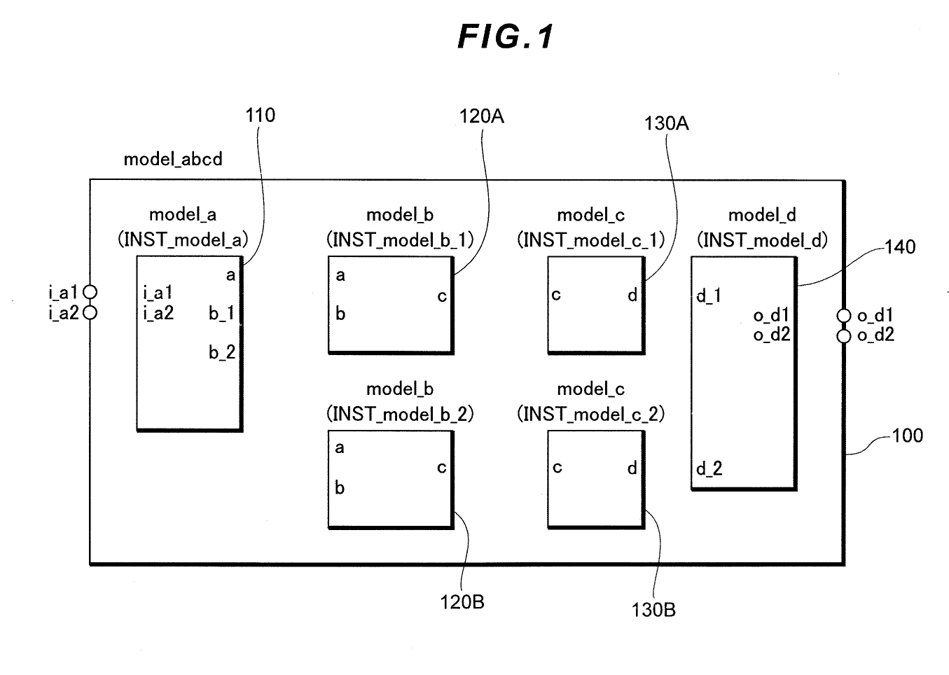

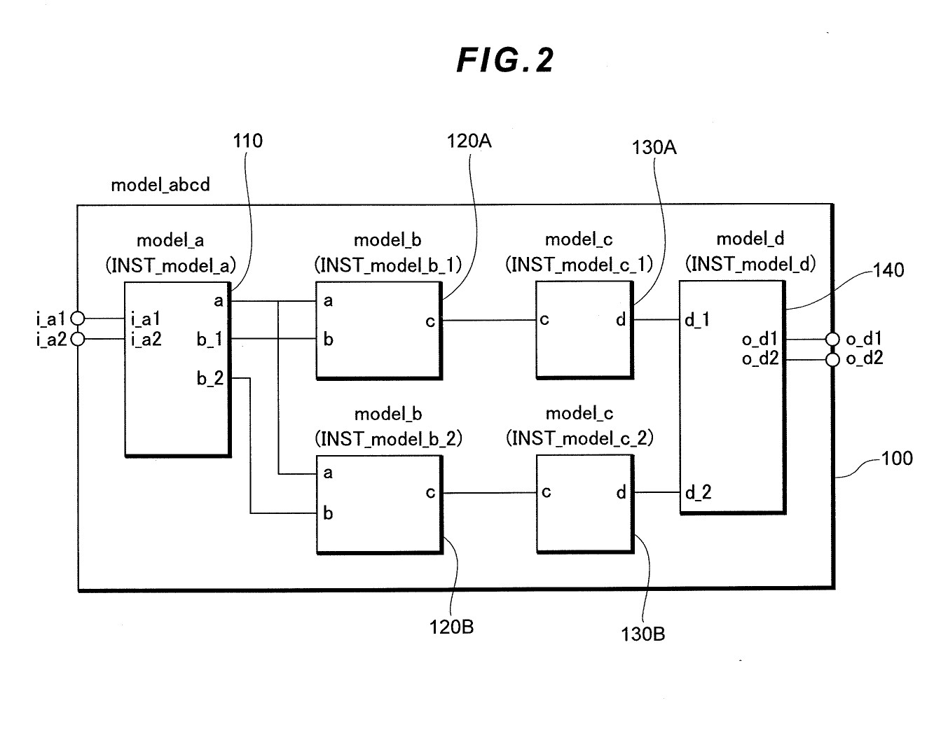

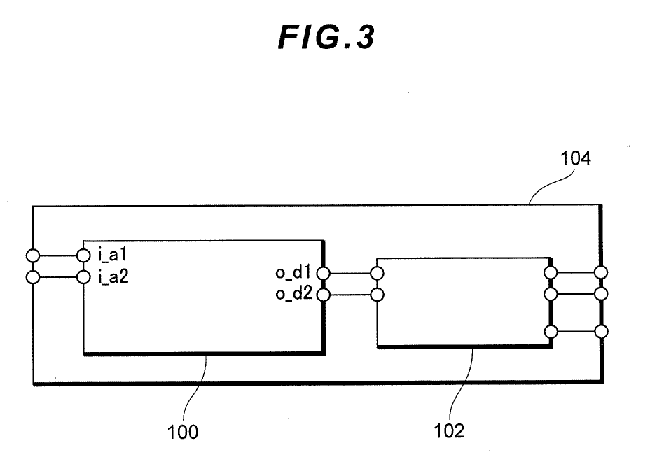

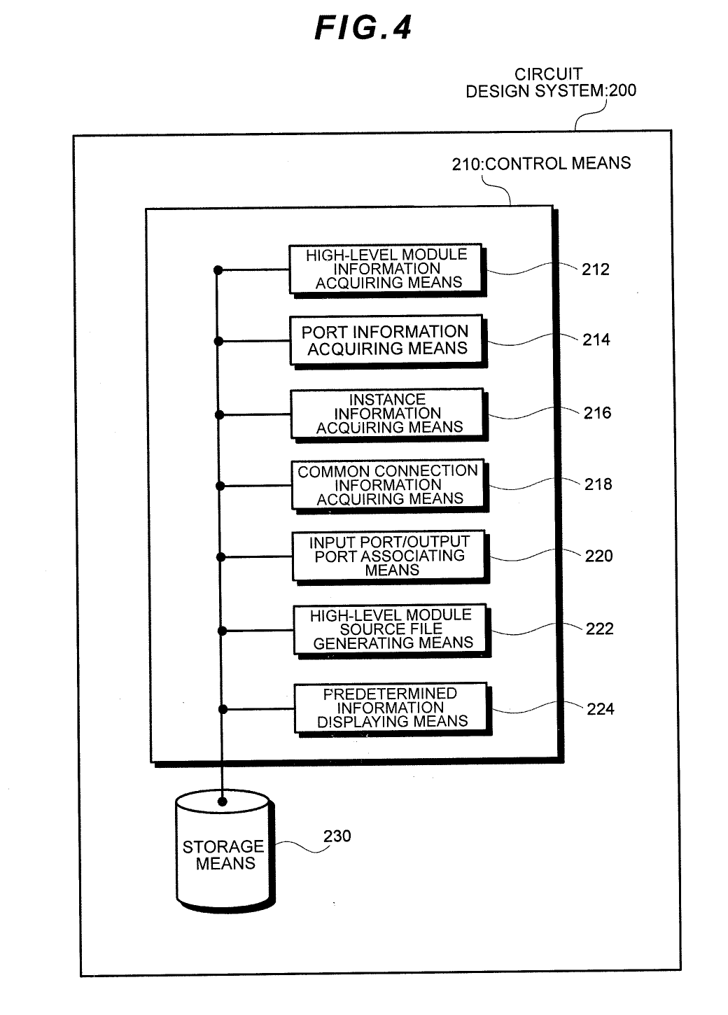

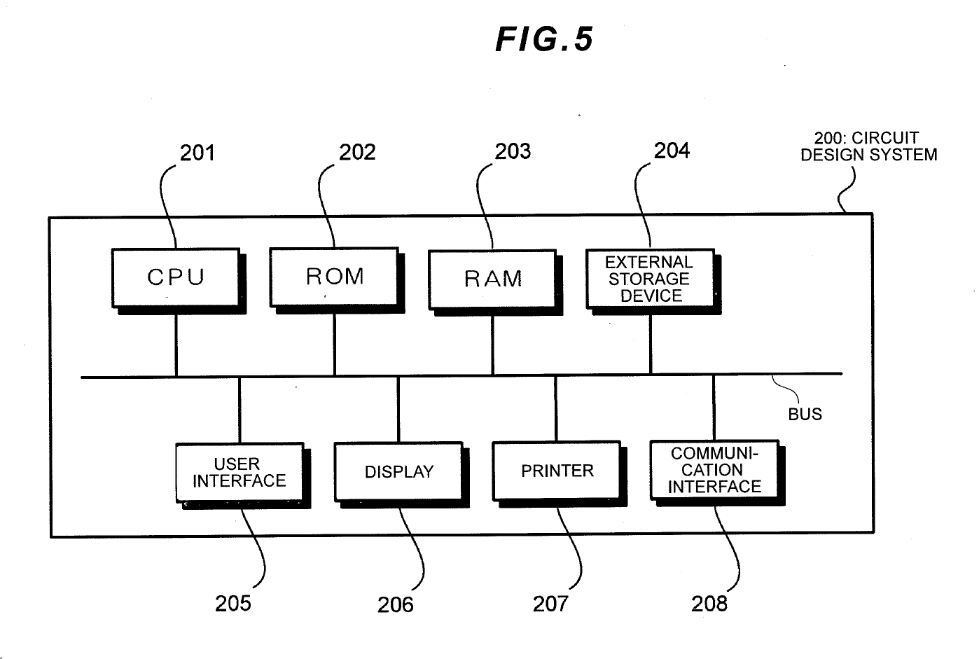

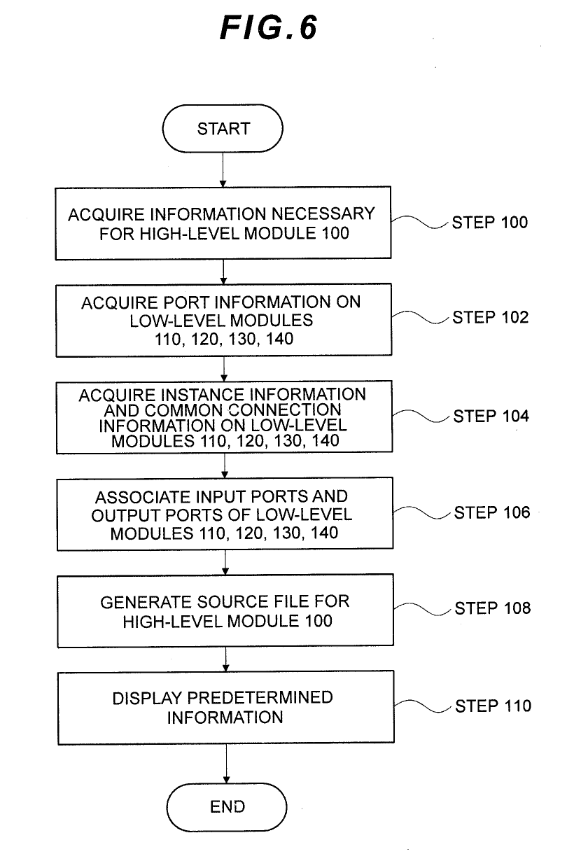

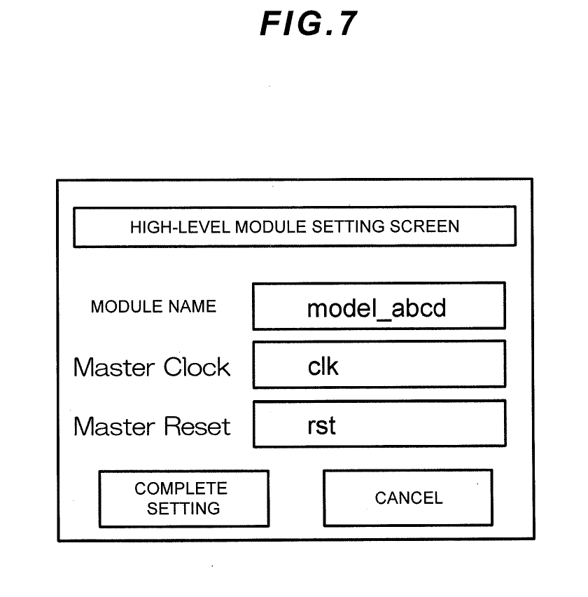

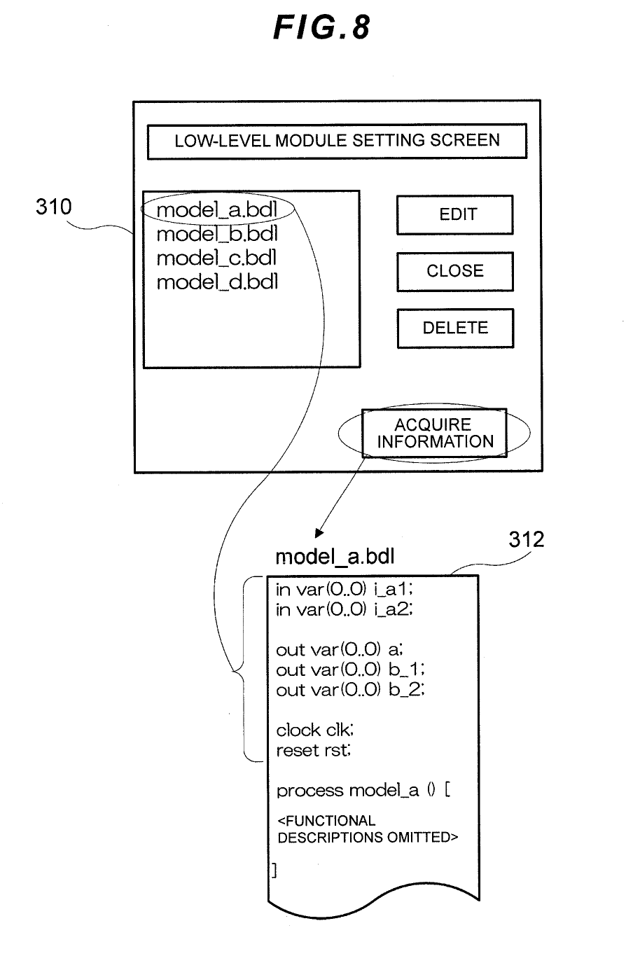

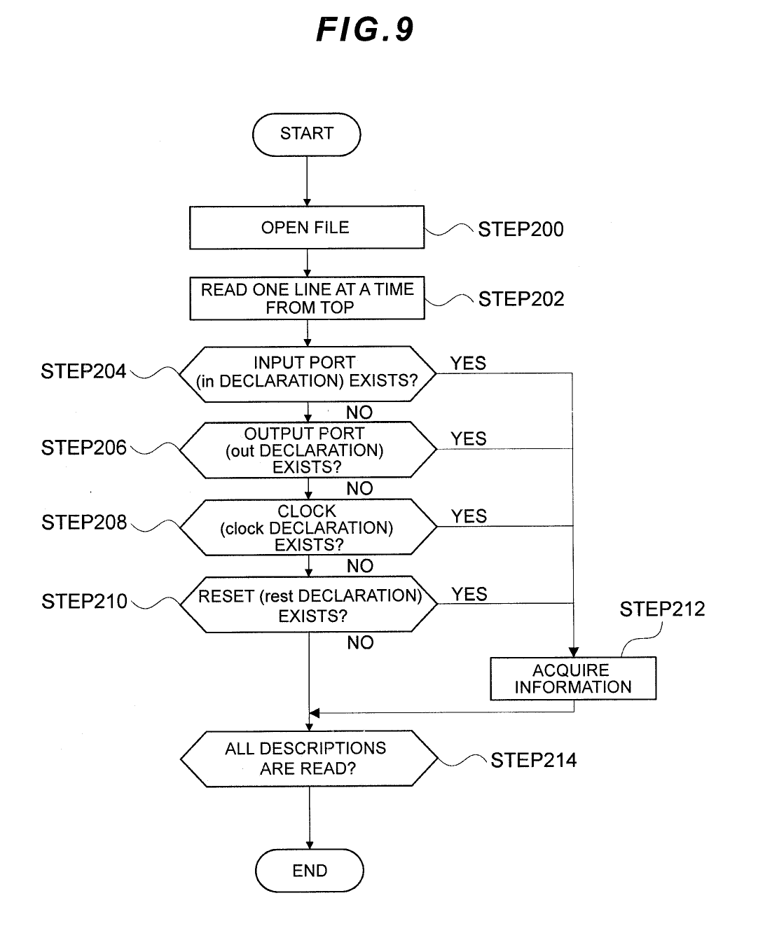

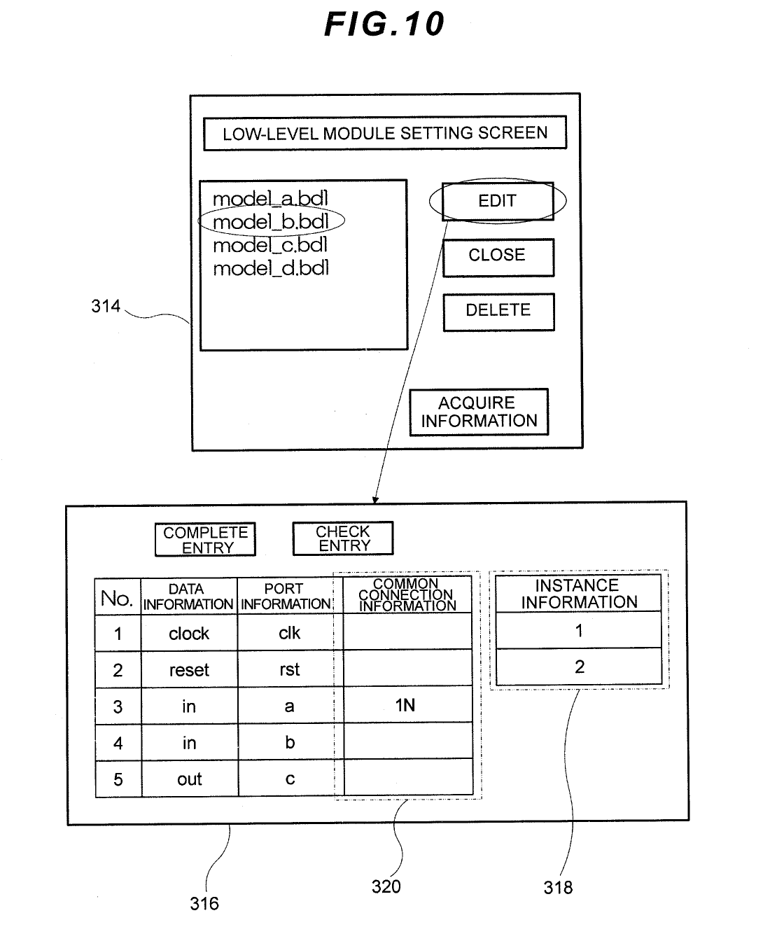

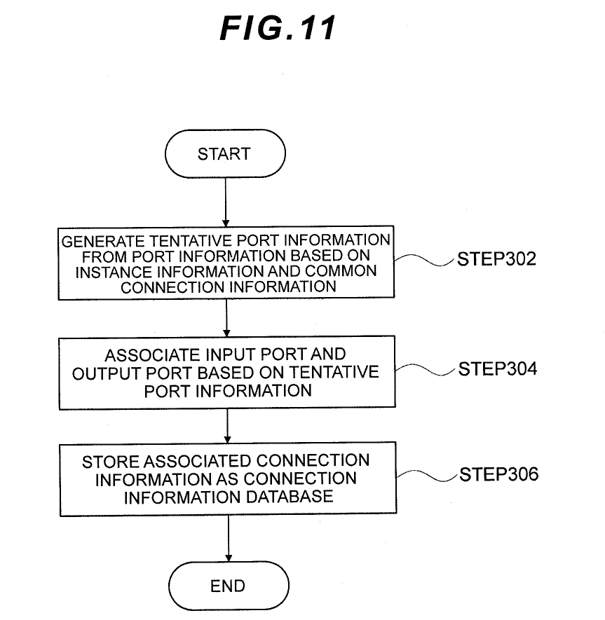

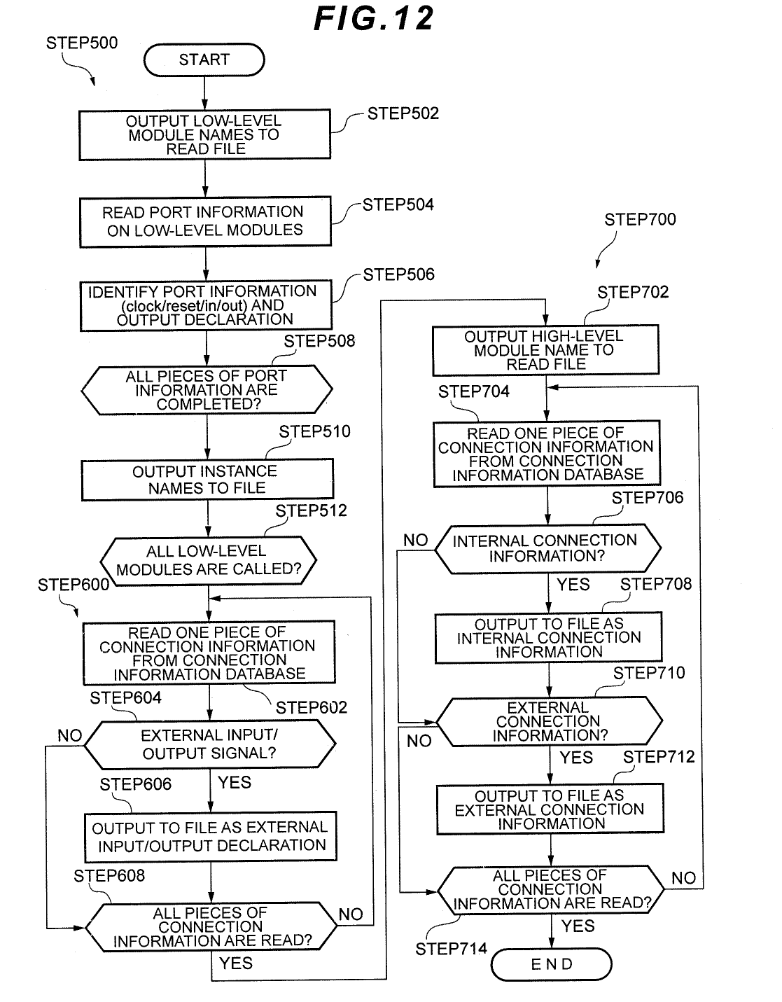

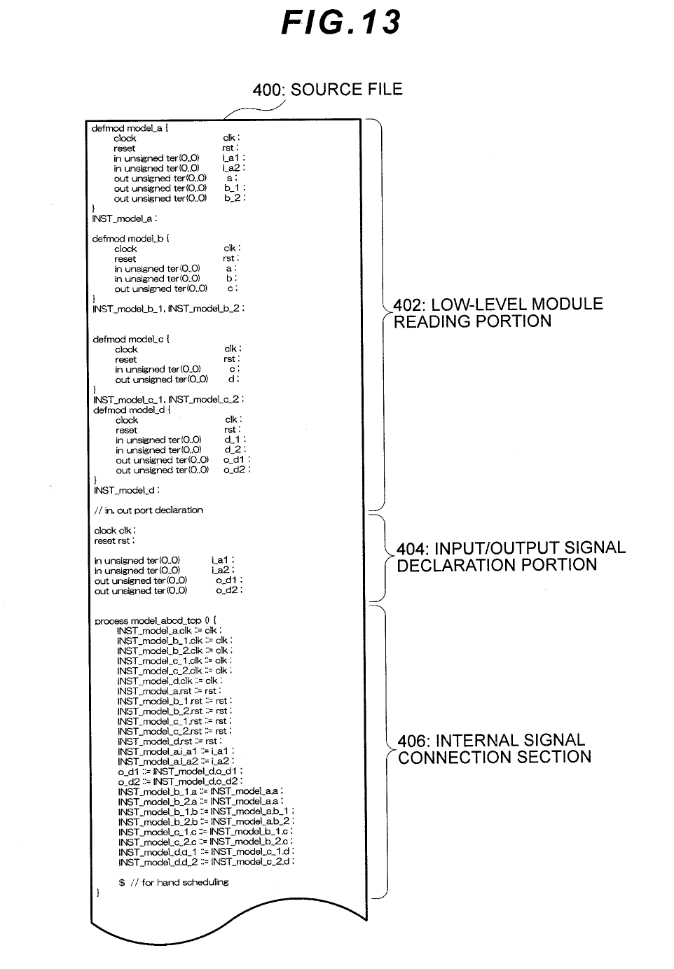

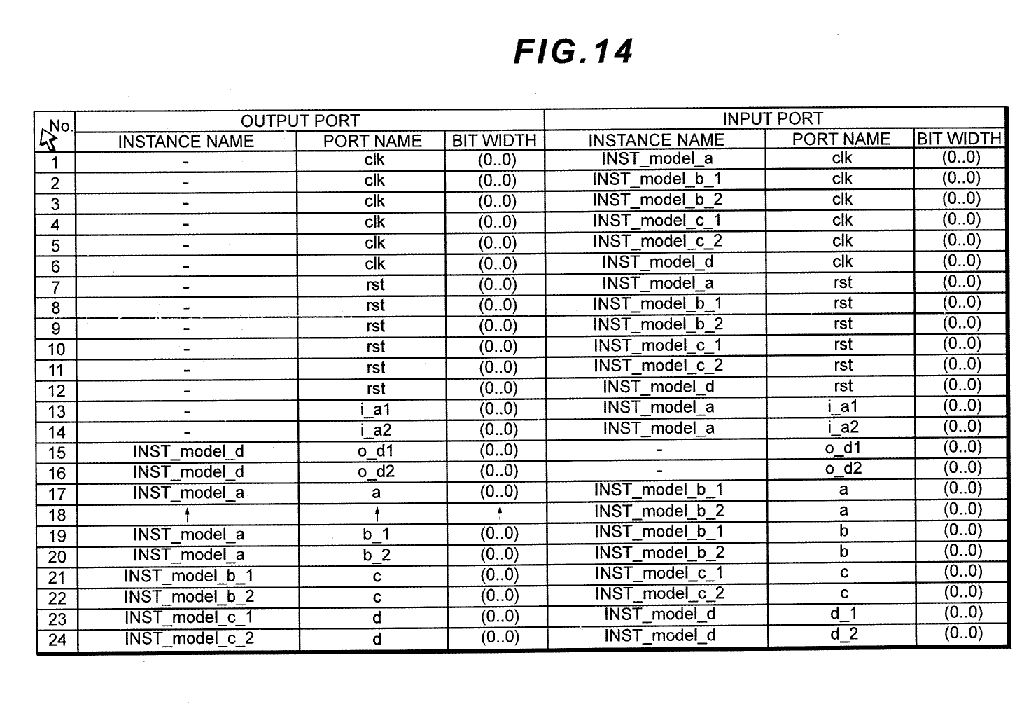

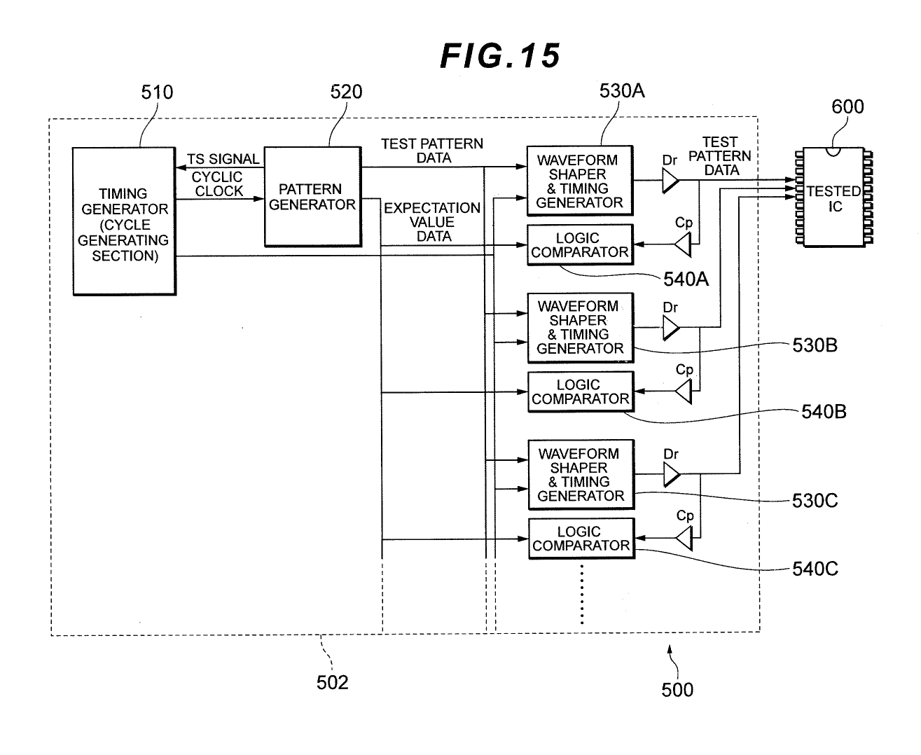

### BRIEF DESCRIPTION OF THE DRAWINGS

[FIG. 1] It is a diagram showing one aspect of a plurality of modules to be interconnected in the embodiment.

[FIG. 2] It is a diagram showing a state in which the plurality of modules in FIG. 1 are interconnected.

[FIG. 3] It is a diagram showing one aspect of high-level modules for those in FIG. 1 and FIG. 2.

[FIG. 4] It is a diagram showing a functional configuration of a circuit design system according to the embodiment.

[FIG. 5] It is a block diagram showing a hardware configuration of the circuit design system according to the embodiment.

[FIG. 6] It is a diagram showing an outline of a circuit design method according to the embodiment.

[FIG. 7] It is a diagram for describing STEP 100 in FIG. 6.

[FIG. 8] It is a diagram for describing STEP 102 in FIG. 6.

[FIG. 9] It is a diagram for describing STEP 102 in FIG. 6.

[FIG. 10] It is a diagram for describing STEP 104 in FIG. 6.

[FIG. 11] It is a diagram for describing STEP 106 in FIG. 6.

[FIG. 12] It is a diagram for describing STEP 108 in FIG. 6.

[FIG. 13] It is a diagram showing an example of a high-level module source file according to the embodiment.

[FIG. 14] It is a diagram showing a display example of a connection information database according to the embodiment. [FIG. 15] It is a diagram showing an application example of the circuit design according to the embodiment.

### DESCRIPTION OF EXEMPLARY EMBODIMENTS

The present invention will now be described through an embodiment of the invention with reference to the accompanying drawings. Note that the following embodiment does not intend to limit the invention according to the appended claims, and all the combinations of the features described in the embodiment should not necessarily be essential to the solving means of the invention.

A circuit design tool according to the embodiment interconnects a plurality of modules divided by function and automatically generates one high-level module. The circuit design tool according to the embodiment can be applied to software provided with a function for automatically generating a program according to a predetermined program language. The following shows an example in which BDL (Behavioral Description Language) language for “Cyber Work Bench (CWB)” provided by NEC System Technologies, Ltd. is used as the program language.

### (1) Modules Processed in the Embodiment

Referring first to FIG. 1 to FIG. 3, modules processed in the embodiment will be described. FIG. 1 and FIG. 2 show one aspect of a plurality of modules to be interconnected in the embodiment, where FIG. 1 shows a state before the plurality of modules are interconnected and FIG. 2 shows a state after the plurality of modules are interconnected. FIG. 3 is a diagram showing one aspect of high-level modules for those in FIG. 1 and FIG. 2.

As shown in FIG. 1, a plurality of modules (module name: model_a, model_b, model_c, model_d)) 110, 120, 130 and 140 are provided in a module (module name: model_abcd) 100. The modules 110, 120, 130 and 140 are obtained by segmenting the module 100 by function. In the relationship between both, the former can be called a low-level module (or lower hierarchy) and the latter can be called a high-level module (or higher hierarchy).

According to the embodiment, as shown in FIG. 1, each of the plurality of low-level modules 110, 120, 130 and 140, which belong to the high-level module 100, is designed, respectively, and the plurality of low-level modules 110, 120, 130 and 140 are associated with each other using a circuit design tool according to the embodiment so that they will be interconnected. Thus, as shown in FIG. 2, one high-level module 100 can be automatically generated. The module 100 thus automatically generated can be associated with another module 102, for example, as shown in FIG. 3, so that they will be interconnected to generate one higher-level module 104. Thus, higher hierarchies are generated in turn so that the circuit design of the entire semiconductor chip will be eventually attained.

Each of the low-level modules 110, 120, 130 and 140 has ports used for sending and receiving data. The ports can include a reference clock port and a reference reset port in addition to an input port and an output port. In the example shown in FIG. 1, the low-level module 110 has input ports (port information: i_a1, i_a2) and output ports (port name: a, b_1, b_2), the low-level module 120 has input ports (port name: a, b) and an output port (port information: c), the low-level module 130 has an input port (port information: c) and an output port (port information: d), and the low-level module 140 has input ports (port information: d_1, d_2) and output ports (port information: o_d1, o_d2). Like the reference clock port and the reference reset port, ports commonly connected to each low-level module and irrelevant to the connection between modules are omitted in FIG. 1 to FIG. 3.

Port information (port name) is attached to each port. In the deign of each individual low-level module, individual ports are provided to send and receive different data, respectively, with different names put for the port information.

The plurality of low-level modules 110, 120, 130 and 140 are arranged in order from the signal input side to the output side, and input/output ports between adjacent modules are connected according to a predetermined correspondence relationship. Thus, the plurality of low-level modules are interconnected. The input ports (port information: i_a1, i_a2) of the low-level module 110 on the most upstream side correspond to the input ports of the high-level module 100, and the output ports (port information: o_d1, o_d2) of the low-level module 140 on the most downstream side correspond to the output ports of the high-level module 100.

As shown in FIG. 1, at least one of the plurality of low-level modules has a plurality of instances having the same function. Here, the instance is to specify each of a plurality of modules having the same function. Thus, the expansion of the plurality of modules having the same function can be called instance expansion.

In the example shown in FIG. 1, the module 120 has a plurality of instances 120A and 120B, and the module 130 has a plurality of instances 130A and 130B. The plurality of modules 120A and 120B (or 130A and 130B) into which instances are expanded have the same port with the same port information attached thereto. In the example shown in FIG. 1, it can be said that the modules 120 and 130 have a plurality of instances, whereas the modules 110 and 140 have one instance, respectively. When there are N modules, modules into which instances are expanded may be at least one module as the first or N-th module, or at least one module in the second to (N-1)-th modules (corresponding to the example shown in FIG. 1), or a combination of them.

The illustrative embodiment of modules shown in FIG. 1 to FIG. 3 is just an example, and the overall number of modules, the number of modules into which instances are expanded, the number of the plurality of instances when the instances are expanded, the number of ports of each module, and the like are not limited to those in the above-mentioned example.

### (2) Outline of Circuit Design System According to the Embodiment

Referring next to FIG. 4 and FIG. 5, an outline of a circuit design system according to the embodiment will be described. Here, FIG. 4 is a diagram showing a functional configuration of the circuit design system according to the embodiment. FIG. 5 is a block diagram showing a hardware configuration of the circuit design system according to the embodiment.

As shown in FIG. 4, a circuit design system 200 with a program for circuit design installed thereon includes, as major components, control means 210 for controlling a circuit design process and storage means 230 for storing information necessary for the circuit design process.

For example, a general-purpose computer including a CPU 201, a ROM 202, a RAM 203, an external storage device 204, a user interface 205, a display 206, a printer 207, and a communication interface 208 as shown in FIG. 5 can be applied to the circuit design system 200. The circuit design system 200 may be configured by a single computer or by a plurality of computers distributed on a network.

The circuit design system 200 is such that the CPU 201 executes a predetermined program (program defining the circuit design process according to the embodiment) stored in the ROM 202, the RAM 203, or the external storage device 204, or downloaded through the communication network to cause the circuit design system 200 to function as various function implementing means (see FIG. 4) to be described later or various steps.

In other words, the control means 210 shown in FIG. 4 includes, as major components, high-level module information acquiring means 212, port information acquiring means 214, instance information acquiring means 216, common connection information acquiring means 218, input port/output port associating means 220, high-level module source file generating means 222, and predetermined information displaying means 224. The various function implementing means is connected to the storage means 230 so that information necessary for the circuit design process and processed by each of the above-mentioned means can be stored in the storage means 230 and read from the storage means 230. The description of various steps in a circuit design method to be described later can be referred to for the description of the various function implementing means.

### (3) Circuit Design Method Using the Circuit Design System According to the Embodiment

Referring next to FIG. 6 to FIG. 14, a specific example of a circuit design method according to the embodiment will be described. The circuit design method according to the embodiment can be performed using the above-mentioned circuit design system 200 (see FIG. 4 and FIG. 5). Respective steps (including partial steps without reference numerals) in flowcharts to be described later can be executed by changing the order arbitrarily or in parallel within a scope which does not entail a contradiction.

Here, FIG. 6 is a diagram showing an outline of the circuit design method according to the embodiment, and FIG. 7 to FIG. 14 are diagrams for describing the details of respective steps of the circuit design method according to the embodiment. Processing to be described below with reference to each diagram can be implemented by executing steps defined in the predetermined program read from the storage means 230 (e.g., RAM 203) under the control of the control means 210 (e.g., CPU 201).

First, as shown in FIG. 6 and FIG. 7, the high-level module information acquiring means 212 acquires information necessary for the high-level module 100 to be generated (STEP 100).

For example, when a user designs a circuit, a predetermined menu screen is displayed on the display 206 so that the processing in STEP 100 may be started by entering input from the menu screen to urge the start of the processing. Also displayed on the display 206 are a plurality of icons corresponding to processing in STEP 100 to STEP 110 shown in FIG. 6 so that input may be provided from the display by clicking on an icon corresponding to the processing in STEP 100. The above illustrative examples are not limited to this step and are applicable to the other steps.

When the processing in STEP 100 is selected, a high-level module setting screen 300 to urge input of information necessary for the high-level module as shown in FIG. 7 is displayed on the display 206. The information necessary for the high-level module includes, for example, the module name, reference clock information (Mater Clock), reference reset information (Master Reset), and the like as shown in FIG. 7. In the embodiment, as shown in FIG. 7, model_abcd, clk, and rst are entered in respective fields. After completion of the entries, an icon “Complete Setting” is clicked so that the procedure can proceed to the next step. The information acquired by the high-level module information acquiring means 212 can be stored in the storage means 230 to read the information in a step to be described later.

Next, as shown in FIG. 6 and FIG. 8, the port information acquiring means 214 acquires port information on the low-level modules 110, 120, 130 and 140 (STEP 102).

When processing in STEP 102 is selected, a low-level module setting screen 310 to urge input of information necessary for the low-level modules as shown in FIG. 8 is displayed on the display 206. On the low-level module setting screen 310, a list of all the low-level modules (model_a, model_b, model_c, model_d) 110, 120, 130 and 140 necessary to generate the high-level module 100 is displayed. Then, the listed low-level modules are selected one by one, a source file 312 of each low-level module is opened, and data of the source file 312 is read into the storage means 230 (e.g., RAM 203). This data reading may also be performed, for example, according to a flowchart shown in FIG. 9. In other words, a predetermined low-level module is first selected from the setting screen 310, and the source file 312 is opened (STEP 200). When the source file 312 is opened, a program described in the file is read one line at a time from the top (STEP 202), the descriptions of an input port (in declaration), an output port (out declaration), a reference clock (clock declaration), and a reference reset (reset declaration) are recognized (STEPS 204 to 210), and if the descriptions exist, each pieces of information is acquired (STEP 212). When reading of all the descriptions in the source file 312 is finally completed (STEP 214), the reading of the data in the source file 312 is ended. The information acquired by the port information acquiring means 214 can be stored in the storage means 230 to read the information in a step to be described later.

Next, as shown in FIG. 6 and FIG. 10, the instance information acquiring means 216 and the common connection information acquiring means 218 acquire instance information on the low-level modules 110, 120, 130 and 140 and common connection information (STEP 104).

When processing in STEP 104 is selected, a low-level module setting screen 314 to urge input of instance information and common connection information on the low-level modules as shown in FIG. 10 is displayed on the display 206. On the low-level module setting screen 314, a list of all the low-level modules (model_a, model_b, model_c, model_d) 110, 120, 130 and 140 necessary to generate the high-level module 100 is displayed. Then, among the listed low-level modules, the modules 120 and 130 including a plurality of instances are selected one by one. First, as shown in FIG. 10, the module (model_b) 120 is selected, and a low-level module information display screen 316 is opened. On the low-level module information display screen 316, an instance information entry field 318 and a common connection information entry field 320 are displayed together with port information on the low-level module 120 and data information indicative of the kind of data acquired in STEP 102. The user enters instance information in the instance information entry field 318 and common connection information in the common connection information entry field 318 based on the port information on the low-level module, predetermined design rules, and the like.

Here, the instance information is information indicating that there is at least a module including a plurality of instances having the same function and capable of including number-of-instances information indicative of the number of the plurality of instances and instance identification information identifying the plurality of instances, respectively. In the example shown in FIG. 10, information (e.g., numeral, symbol or character string) for identifying each of the plurality of instances is entered in each of a plurality of cells corresponding to the number of instances in the item of “Instance Information” in the instance information entry field 318. For example, since the number of instances in the module 120 is two, information “1” identifying an instance is entered in the first cell and information “2” identifying another instance is entered in the second cell. Thus, both the number-of-instances information and the instance identification information can be entered at the same time.

The information entered as the instance identification information can be decided based on port information (e.g. “signal name_expanded value”) on the output ports of the module 110 on the upstream side of the module 120 into which the instances are expanded, or port information (e.g., “signal name_expanded value”) on the input ports of the module 140 on the downstream side of the module 130 into which instances are expanded. In other words, as shown in FIG. 2, since the output ports of the module 110 has ports (port information: b_1, b_2) corresponding to each of the plurality of modules 120A and 120B into which instances are expanded, the information entered beforehand as the instance identification information may be matched to the expanded values of the port information (e.g., information “1” and “2” following the underbars) so that both pieces of tentative port information will match each other in associating ports to be described later. Similarly, since the input ports of the module 140 has ports (port information: d_1, d_2) corresponding to the plurality of modules 130A and 130B into which instances are expanded, the information entered beforehand as the instance identification information may be matched to the expanded values of the port information so that both pieces of tentative port information will match each other in associating the ports. If the correspondence between the ports to be described later can be established, the instance identification information will not necessarily need to be matched to the expanded value of the port information, and a numeral, symbol, or a character string different from the expanded value of the port information may be entered.

On the other hand, the common connection information is information indicating that the output port of a predetermined module is commonly connected to each input port of the plurality of instances. In other words, as shown in FIG. 2, when the output port (port information: a) of the module 110 is commonly connected to each input port (port information: a) of the plurality of modules 120A and 120B into which instances are expanded, predetermined information (e.g., numeral, symbol, or character string) is entered in a cell corresponding to port information a in the item of “Common Connection Information” in the common connection information entry field 320. In the example shown in FIG. 10, “1N” is entered in the cell corresponding to port information a in the item of “Common Connection Information.” The information entered as the common connection information is not limited to the above character string as long as it can identify that the port is to be commonly connected.

Note that the information acquired by the instance information acquiring means 216 and the common connection information acquiring means 218 can be stored in the storage means 230 to read the information in a step to be described later.

Although in STEP 104 the example in which both the instance information and the common connection information are acquired is described, if there is no aspect in which the output port of the predetermined module is commonly connected to each input port of the plurality of instances, the common connection information will not need acquiring. In this case, it is enough that the instance information acquiring means 216 acquires the instance information on the low-level modules 110, 120, 130 and 140.

Next, as shown in FIG. 6 and FIG. 11, the input port/output port associating means 220 associates the input ports and the output ports of the low-level modules 110, 120, 130 and 140 (STEP 106).

FIG. 11 is a flowchart for describing STEP 106 in more detail. First, when processing in STEP 106 is selected, the input port/output port associating means 220 reads necessary information prestored in the storage means 230 to generate tentative port information from the port information acquired in STEP 102 based on the instance information and the common connection information acquired in STEP 104 (STEP 302).

Table 1 shows an input information database of tentative port information generated from the port information on the input ports, and Table 2 shows an output information database of tentative port information generated from the port information on the output port.

TABLE 1
INPUT INFORMATION DATABASE

| MODULE | INSTANCE | PORT | TENTATIVE PORT | |
|---|---|---|---|---|
| NAME | NAME | INFORMATION | INFORMATION | DESCRIPTION |
| model_a | INST_model_a | i_a1 | i_a1 | TENTATIVE PORT INFORMATION REMAINS |
| | | i_a2 | i_a2 | AS PORT INFORMATION |
| model_b | INST_model_b_1 | a | a | TENTATIVE PORT INFORMATION REMAINS |
| | | | | AS PORT INFORMATION BASED ON COMMON |
| | | | | CONNECTION INFORMATION |
| | | b | b_1 | TENTATIVE PORT INFORMATION IS |
| | | | | CHANGED BASED ON INSTANCE INFORMATION |
| | INST_model_b_2 | a | a | TENTATIVE PORT INFORMATION REMAINS |
| | | | | AS PORT INFORMATION BASED ON COMMON |
| | | | | CONNECTION INFORMATION |
| | | b | b_2 | TENTATIVE PORT INFORMATION IS |
| | | | | CHANGED BASED ON INSTANCE INFORMATION |
| model_c | INST_model_c_1 | c | c_1 | TENTATIVE PORT INFORMATION IS |
| | | | | CHANGED BASED ON INSTANCE INFORMATION |
| | INST_model_c_2 | c | c_2 | TENTATIVE PORT INFORMATION IS |
| | | | | CHANGED BASED ON INSTANCE INFORMATION |
| model_d | INST_model_d | d_1 | d_1 | TENTATIVE PORT INFORMATION REMAINS |
| | | d_2 | d_2 | AS PORT INFORMATION |

TABLE 2
OUTPUT INFORMATION DATABASE

| MODULE | INSTANCE | PORT | TENTATIVE PORT | |
|---|---|---|---|---|
| NAME | NAME | INFORMATION | INFORMATION | DESCRIPTION |
| model_a | INST_model_a | a | a | TENTATIVE PORT INFORMATION REMAINS |
| | | b_1 | b_1 | AS PORT INFORMATION |
| | | b_2 | b_2 | |
| model_b | INST_model_b_1 | c | c_1 | TENTATIVE PORT INFORMATION IS |
| | | | | CHANGED BASED ON INSTANCE INFORMATION |
| | INST_model_b_2 | c | c_2 | TENTATIVE PORT INFORMATION IS |
| | | | | CHANGED BASED ON INSTANCE INFORMATION |
| model_c | INST_model_c_1 | d | d_1 | TENTATIVE PORT INFORMATION IS |
| | | | | CHANGED BASED ON INSTANCE INFORMATION |
| | INST_model_c_2 | d | d_2 | TENTATIVE PORT INFORMATION IS |
| | | | | CHANGED BASED ON INSTANCE INFORMATION |
| model_d | INST_model_d | o_d1 | o_d1 | TENTATIVE PORT INFORMATION REMAINS |
| | | o_d2 | o_d2 | AS PORT INFORMATION |

It is apparent from Table 1 and Table 2 that, since those into which no instance is expanded are not also given instance information and common connection information for generating tentative port information, the same information as the port information is first displayed as tentative port information (tentative port information: i_a1, i_a2, d_1, d_2, o_d1, o_d2). Next, for those into which instances are expanded, tentative port information is generated based on the instance information (tentative port information: b_1, b_2, c_1, c_2). In other words, the port information is changed to different tentative port information based on the instance information. In this case, as mentioned above, the information entered beforehand as the instance identification information is matched to the expanded value of the port information, so that ports to be associated can match each other in terms of the tentative port information. Finally, for those into which instances are expanded and for which the common connection information is entered, tentative port information is generated based on the common connection information (tentative port information: a). In other words, this common connection information interferes with the change of the port information to different tentative port information, and the port information is displayed intact as the tentative port information. Thus, the input information database (Table 1) and the output information database (Table 2) are created and each database is stored in the storage means 230, for example.

Next, an input port and an output port are associated based on the generated tentative port information (STEP 304). In the embodiment, since the ports to be associated are matched to each other in terms of the tentative port information, the association between the input port and the output port can be determined based on whether the tentative port information matches or not. For example, the tentative port information in the output information database (Table 2) is read one by one and compared with the tentative port information in the input information database (Table 1). If both match, it is determined that these pieces of tentative port information are so associated that both are to be interconnected, and the associated connection information is registered as a connection information database. Table 3 shows an aspect of the connection information database.

TABLE 3
CONNECTION INFORMATION DATABASE

| OUTPUT SIDE | | INPUT SIDE | |
|---|---|---|---|
| | PORT | | PORT |
| INSTANCE | INFOR- | INSTANCE | INFOR- |
| NAME | MATION | NAME | MATION |
| — | i_a1 | INST_model_a | i_a1 |
| — | i_a2 | INST_model_a | i_a2 |
| INST_model_a | a | INST_model_b_1 | a |
| | | INST_model_b_2 | a |
| INST_model_a | b_1 | INST_model_b_1 | b |
| INST_model_a | b_2 | INST_model_c_1 | b |
| INST_model_b_1 | c | INST_model_c_2 | c |
| INST_model_b_2 | c | INST_model_c_2 | c |
| INST_model_c_1 | d | INST_model_d | d_1 |
| INST_model_c_2 | d | INST_model_d | d_2 |
| INST_model_d | o_d1 | — | o_d1 |
| INST_model_d | o_d2 | — | o_d2 |

As shown in Table 3, information registered as the connection information database includes the output side instance name and port information, the input side instance name and port information, and connection information between the input port and the output port. The generated connection information database can be eventually stored in the storage means 230.

The connection information database shown in Table 3 may be displayed on the display 206. For example, it may be displayed as a list as shown in FIG. 14 to allow the user to view information based on the connection information database. The display mode to be output to the display 206 is not particularly limited, but at least information indicative of the instance name, the port name (port information), and connection information between the input port and the output port to interconnect a plurality of modules can be included.

Next, as shown in FIG. 6 and FIG. 12, the high-level module source file generating means 222 generates a source file of the high-level module 100 (STEP 108). Here, FIG. 12 is a diagram showing a flowchart of processing for generation of a high-level module source file, and FIG. 13 shows an example of the high-level module source file generated according to the flowchart of FIG. 12.

As shown in FIG. 13, a high-level module source file 400 includes, as major components, a low-level module reading portion 402, an input/output signal declaration portion 404, and an internal signal connection portion 406. Any of the components can be generated based on information or databases stored in the storage means 230 in the steps described so far.

As shown in FIG. 12, this source file 400 can be generated in such a manner that the reading portion for the low-level modules 110, 120, 130 and 140 is first generated (STEP 500), the input/output declaration portion for the high-level module 100 is next generated (STEP 600), and finally the internal signal connection portion for the high-level module 100 is generated (STEP 700).

First, in STEP 500, the low-level module names are read and output to a read file (STEP 502), and port information on the low-level modules is next read (STEP 504). Then, the port information (clock/reset/in/out) is identified and a declaration is output to the file (STEP 506). Upon completion of processing all pieces of port information (STEP 508), instance names are output to the file (STEP 510) to check whether all the low-level modules are called (STEP 512). Thus, a source file portion for the low-level module reading portion 402 shown in FIG. 13 can be generated.

Next, in STEP 600, one piece of connection information (one line in the example of Table 3) is read from the connection information database (see Table 3) (STEP 602) to determine whether the read connection information is an external input/output signal (STEP 604). As a result, if it is an external input/output signal, the effect is output as an external input/output declaration to the file (STEP 606). If it is not an external input/output signal, it is determined whether all pieces of connection information are read (STEP 608), and if there is any remaining piece of connection information, the procedure returns to STEP 604 to repeat the above-mentioned procedure. Thus, all pieces of connection information are eventually read so that a source file portion for the input/output signal declaration portion 404 shown in FIG. 13 can be generated.

Then, in STEP 700, the high-level module name is read and output to the file (STEP 702), and as also described in STEP 600, one piece of connection information is next read from the connection information database (see Table 3) (STEP 704) to determine whether the read connection information is internal connection information (STEP 706). As a result, if it is internal connection information, the effect is output to the file (STEP 708). If it is not internal connection information, it is then determined whether it is external connection information (STEP 710). As a result, if it is external connection information, the effect is output to the file (STEP 712). Or, if it is not external connection, it is determined whether all pieces of connection information are read (STEP 714), and if there is any remaining piece of connection information, the procedure returns to STEP 704 to repeat the above-mentioned procedure. Thus, all pieces of connection information are eventually read so that a source file portion for the internal signal connection portion 406 shown in FIG. 13 can be generated.

Thus, according to the circuit design method according to the embodiment, since the high-level module 100 can be automatically generated, not only the quality of a model to be designed but also the design productivity can be improved.

According to the circuit design method of the embodiment, the example in which the program language BDL for “Cyber Work Bench” is used is shown, but the program language is not limited thereto, and any other program language can be applied by changing the routine for creating the source file.

### (4) Application Example of Circuit Design According to the Embodiment

Referring next to FIG. 15, an application example of the circuit design according to the embodiment will be described. The circuit design according to the embodiment can be applied to the circuit design of a semiconductor device (e.g., ASIC) used for a semiconductor testing device.

A semiconductor device 502 used for a semiconductor testing device 500 includes a plurality of modules, such as a timing generator 510, a pattern generator 520, waveform shaper and timing generator 530, and a logic comparator 540, to conduct a test on a tested IC 600. Among them, a plurality of instances are expanded into the waveform shaper and timing generator 530, and the logic comparator 540, respectively, that is, instances are expanded into a plurality of modules 530A to C and 540C having the same functions. For example, when instances corresponding to the number of many external terminals of the tested IC to be measured are expanded, it means that the waveform shaper and timing generator 530, and the logic comparator 540 include many instances, respectively.

Therefore, in the circuit design of the semiconductor device 502 including modules having so many instances, if the circuit design system 200 and the circuit design method according to the aforementioned embodiment is applied, high-level modules can be automatically generated as easy as anything, so that the quality of a model and design productivity can be improved effectively.

Since the examples and the application example described with reference to the aforementioned embodiment of the invention can be combined appropriately in accordance with the intended use, or used while making a change or modification, the present invention should not be limited to the aforementioned embodiment. It will be apparent from the appended claims that a form to which such a combination or change or modification is added can also be included in the technical scope of the present invention.

### DESCRIPTION OF REFERENCE NUMERALS

100 . . . high-level module
110, 120, 130, 140 . . . low-level module
210 . . . control means
212 . . . high-level module information acquiring means
214 . . . port information acquiring means
216 . . . instance information acquiring means
218 . . . common connection information acquiring means
220 . . . input port/output port associating means
222 . . . high-level module source file generating means
224 . . . predetermined information displaying means
230 . . . storage means.

1. A circuit design method for interconnecting a plurality of modules, the method comprising:
a step of acquiring port information including input ports and output ports of the plurality of modules;
a step of acquiring instance information indicating that, among the plurality of modules, there is a module including a plurality of instances having an identical function; and
a step of associating the input ports and the output ports based on the port information and the instance information to interconnect the plurality of modules.

2. The method according to claim 1, wherein the instance information includes number-of-instances information indicative of the number of the plurality of instances.

3. The method according to claim 1, wherein the instance information includes instance identification information identifying each of the plurality of instances, respectively.

4. The method according to claim 1, wherein the associating step includes generating tentative port information from the port information based on the instance information and associating the input ports and the output ports based on the tentative port information to interconnect the plurality of modules.

5. The method according to claim 1, further comprising
a step of acquiring common connection information indicating that an output port of a predetermined module is commonly connected to each input port of the plurality of instances,
wherein the associating step includes generating tentative port information from the port information based on the instance information and the common connection information and associating the input ports and the output ports based on the tentative port information to interconnect the plurality of modules.

6. The method according to claim 1, further comprising, before the step of acquiring the port information, a step of acquiring information on a high-level module generated by interconnecting the plurality of modules.

7. The method according to claim 1, further comprising, after the associating step, a step of storing the associated connection information as a connection information database.

8. The method according to claim 1, further comprising, after the associating step, a step of generating a source file of a high-level module generated by interconnecting the plurality of modules.

9. The method according to claim 1, further comprising, after the associating step, a step of displaying at least information indicative of instance names, the port information, and the connection information between the input ports and the output ports to interconnect the plurality of modules.

10. The method according to claim 1, wherein the method is applied to circuit design of a semiconductor device used for a semiconductor testing device.

11. A circuit design system for interconnecting a plurality of modules, the system comprising:
port information acquiring means for acquiring port information including input ports and output ports of the plurality of modules;
instance information acquiring means for acquiring instance information indicating that, among the plurality of modules, there is a module including a plurality of instances having an identical function; and
association means for associating the input ports and the output ports based on the port information and the instance information to interconnect the plurality of modules.

12. A computer readable recording medium storing a program for interconnecting a plurality of modules, the program executing:
a step of acquiring port information including input ports and output ports of the plurality of modules;
a step of acquiring instance information indicating that, among the plurality of modules, there is a module including a plurality of instances having an identical function; and
a step of associating the input ports and the output ports based on the port information and the instance information to interconnect the plurality of modules.
